(19) United States
(12) Patent Application Publication
(10) Pub. No.: US 2026/0219468 A1
(43) Pub. Date: Jul. 30, 2026

(54) FULL-DRY LOOSE TUBE, MANUFACTURING METHOD AND MANUFACTURING APPARATUS THEREOF, AND OPTICAL CABLE

(71) Applicant: Jiangsu Zhongtian Technology Co., Ltd., Jiangsu (CN)

(72) Inventors: Jing ZHAO, Jiangsu (CN); Jianqiu XU, Jiangsu (CN); Pengyu ZHU, Jiangsu (CN); Xinmin MA, Jiangsu (CN); Weiwei MIAO, Jiangsu (CN); Xiaoming MIAO, Jiangsu (CN); Huihui QIAN, Jiangsu (CN); Feng TAN, Jiangsu (CN)

(73) Assignee: Jiangsu Zhongtian Technology Co., Ltd., Jiangsu (CN)

(21) Appl. No.: 19/000,754

(22) Filed: Dec. 24, 2024

Related U.S. Application Data
(63) Continuation of application No. PCT/CN2024/080246, filed on Mar. 6, 2024.

(30) Foreign Application Priority Data
Nov. 23, 2023 (CN) 202311579332.5

(51) Int. Cl. G02B 6/44; B29D 11/00

(52) U.S. Cl. CPC G02B 6/44384; B29D 11/00663

(57) ABSTRACT

A full-dry loose tube, a manufacturing method and a manufacturing apparatus thereof, and an optical cable, where the manufacturing apparatus includes: a releasing device; an optical-element electrostatic polarization device, performing electrostatic polarization on an optical element; a coupling device, receiving the optical element which is electrostatically polarized; a water-blocking-powder electrostatic polarization device, connected to the coupling device, and delivering water-blocking powder which is electrostatically polarized to the coupling device, for coupling with the optical element to form an optical fiber bundle, where polarity of the optical element is opposite to polarity of the water-blocking powder; an extruder, receiving the optical fiber bundle and covering the optical fiber bundle with a plastic layer; a vacuum water tank, rounding the optical fiber bundle which is covered with the plastic layer to form the loose tube; and a cooling water tank.

### CROSS-REFERENCE TO RELATED APPLICATION

This application is a continuation of International Application No. PCT/CN2024/080246, filed on Mar. 6, 2024, which claims priority to Chinese Patent Application No. 202311579332.5, filed on Nov. 23, 2023. The disclosures of the aforementioned applications are hereby incorporated by reference in their entireties.

### TECHNICAL FIELD

The present disclosure relates to the technical field of optical cables, and in particular relates to a full-dry loose tube, a manufacturing method and a manufacturing apparatus thereof, and an optical cable.

### BACKGROUND

Compared with a traditional gel-filled optical cable, a full-dry optical cable has advantages of light cable weight, convenient optical-fiber connection, and cleanliness and environmental friendliness, and is widely applied in overseas markets.

At present, in terms of structural design of the full-dry optical cable, there are water-blocking yarn and water-blocking powder for water-blocking materials used for a loose tube. Since the water-blocking powder imposes high requirements on a filling process, and technical difficulties such as uneven dispersion, mold blockage and impacts to the tube size exist in a production process, most full-dry optical cables adopt the water-blocking yarn in the loose tube to block water.

When filling the loose tube of the optical cable with the water-blocking yarn, the water-blocking yarn, due to its material characteristics, is prone to irregular stranding with the optical fiber, so that there is an excessive exceeded length resulting from local accumulation between the water-blocking yarn and the optical fiber, in turn producing adhesion to an inner wall of the loose tube, and at the same time squeezing the optical fiber to affect the attenuation of the optical fiber. During a practical production process, in order to avoid such risks, a large-sized loose tube is required to ensure sufficient internal space, which is not conducive to outer diameter control and cost control of the loose tube. Replacing the water-blocking yarn with the water-blocking powder may reduce the negative effect on the optical fiber, and improve the fiber core density, and at the same time, the optical cable can be used in a wider range of environmental temperatures. However, in the filling process of the water-blocking powder, the existing technology cannot achieve effective coupling between the water-blocking powder and optical elements, and problems such as uneven distribution, mold blockage and even powder falling-off may occur, which affects the water-blocking performance and production efficiency of the loose tube.

### SUMMARY

The main objective of the present disclosure is to provide a full-dry loose tube, a manufacturing method and a manufacturing apparatus thereof, and an optical cable, which can achieve the active coupling between an optical element and water-blocking powder, ensure the uniform distribution of the water-blocking powder, and improve the roundness of the loose tube.

In order to achieve the above objective, an aspect of the present disclosure provides a manufacturing apparatus of a full-dry loose tube, including:
a releasing device;
an optical-element electrostatic polarization device, disposed downstream of the releasing device, and performing electrostatic polarization on an optical element which enters the optical-element electrostatic polarization device;
a coupling device, disposed downstream of the optical-element electrostatic polarization device, and receiving the optical element which is electrostatically polarized by the optical-element electrostatic polarization device;
a water-blocking-powder electrostatic polarization device, connected to the coupling device, and delivering water-blocking powder which is electrostatically polarized to the coupling device, for coupling with the optical element to form an optical fiber bundle, where polarity of the optical element is opposite to polarity of the water-blocking powder;
an extruder, receiving the optical fiber bundle and covering the optical fiber bundle with a plastic layer;
a vacuum water tank, disposed downstream of the extruder, and rounding the optical fiber bundle which is covered with the plastic layer to form the loose tube; and
a cooling water tank, cooling the loose tube which is rounded.

Further, the manufacturing apparatus further includes a gas filling device, the gas filling device is disposed upstream of the extruder, and injects gas with a preset pressure into the plastic layer when the extruder covers the optical fiber bundle with the plastic layer.

Further, the coupling device includes a coupling box, the coupling box includes an optical element inlet mold, an optical element outlet mold and a water-blocking powder inlet mold, the optical element inlet mold has a plurality of inlet holes, and a plurality of optical elements enter the coupling device through the inlet holes; the optical element outlet mold is disposed at an opposite side of the optical element inlet mold, and has an outlet hole; the water-blocking powder inlet mold is disposed at an upper side of the coupling device, and is connected with a spray gun of the water-blocking-powder electrostatic polarization device.

Further, centers of the plurality of inlet holes of the optical element inlet mold are located at a same circle, the circle is coaxially provided with the outlet hole, and the optical element inlet mold is rotatable relative to a central axis of the outlet hole.

Further, the optical element inlet mold is a detachable structure.

Further, the coupling device further includes a vibrating screen and a water-blocking powder recycling device, the coupling box is open at its bottom, the vibrating screen is disposed at the bottom of the coupling box, and the water-blocking powder recycling device is disposed below the vibrating screen.

Further, the water-blocking powder recycling device includes a heating device, a conduit and a pneumatic device, the conduit is connected with a storage container for storing the electrostatically polarized water-blocking powder, the heating device is configured to heat the water-blocking powder recycled in the water-blocking powder recycling device, and the pneumatic device is configured to suck the water-blocking powder to the storage container.

Another aspect of the present disclosure provides a manufacturing method of a full-dry loose tube, applied to the above-mentioned manufacturing apparatus, including:
releasing the optical element;
performing electrostatic polarization on the released optical element;
adding the water-blocking powder which is electrostatically polarized and has the opposite polarity, to the electrostatically polarized optical element, so that the optical element and the water-blocking powder are coupled to form the optical fiber bundle;
extruding the optical fiber bundle and making the extruded optical fiber bundle form the loose tube; and
shaping, cooling and retracting the loose tube.

Further, a step of extruding the optical fiber bundle and making the extruded optical fiber bundle form the loose tube includes:
injecting gas into the plastic layer during an extruding process, so that the plastic layer is hollow inside to form the loose tube;
delivering the loose tube to the vacuum water tank, and adjusting roundness of the loose tube by using the vacuum water tank.

Further, a step of adding the water-blocking powder which is electrostatically polarized and has the opposite polarity, to the electrostatically polarized optical element, so that the optical element and the water-blocking powder are coupled to form the optical fiber bundle includes:
controlling a plurality of optical elements to be twisted and stranded, and adding the water-blocking powder during a twisting and stranding process, where the water-blocking powder is sprayed from top to bottom by the spray gun of the water-blocking-powder electrostatic polarization device through the water-blocking powder inlet mold.

Another aspect of the present disclosure provides a loose tube, applying the above-mentioned manufacturing method, where the loose tube includes a plastic layer, water-blocking powder and an optical element, the water-blocking powder is coated outside the optical element to form an optical fiber bundle, the plastic layer is covered outside the optical fiber bundle, the plastic layer includes an inner surface, and the inner surface includes a rounding surface and a concave surface.

Further, a radian proportion by which the concave surface occupies the inner surface of the plastic layer is 10% to 25%.

Further, a curvature radius of the concave surface is less than or equal to half of thickness of the plastic layer in which the concave surface is located; and/or a radian of the concave surface ranges from 0 to π.

Further, the concave surface is a rough surface.

Further, the plastic layer is filled with at least one anti-shrinkage film continuously extending along an axial direction of the loose tube, and the anti-shrinkage film is arc-shaped on a cross section of the loose tube.

Further, the anti-shrinkage film has a longitudinal shrinkage ratio of ≤0.2% at 250° C. to 300° C., a thickness of 0.05 mm to 0.2 mm, and a width of 0.5 mm to 5 mm.

Further, an outer diameter of the loose tube ranges from 0.8 mm to 20 mm, and a wall thickness ranges from 0.08 mm to 1 mm; when the outer diameter of the loose tube is less than or equal to 5.0 mm, the plastic layer is made of one of PBT, PP, TPEE and PC; when the outer diameter of the loose tube is greater than 5.0 mm, the plastic layer is made of one of TPEE, PE and PP.

Another aspect of the present disclosure provides an optical cable, including a cable core prepared by the above-mentioned loose tube and an outer sheath covering the cable core.

According to the technical solutions applied in the present disclosure, the manufacturing apparatus of the full-dry loose tube includes: a releasing device; an optical-element electrostatic polarization device, disposed downstream of the releasing device, and performing electrostatic polarization on an optical element which enters the optical-element electrostatic polarization device; a coupling device, disposed downstream of the optical-element electrostatic polarization device, and receiving the optical element which is electrostatically polarized by the optical-element electrostatic polarization device; a water-blocking-powder electrostatic polarization device, connected to the coupling device, and delivering water-blocking powder which is electrostatically polarized to the coupling device, for coupling with the optical element to form an optical fiber bundle, where polarity of the optical element is opposite to polarity of the water-blocking powder; an extruder, receiving the optical fiber bundle and covering the optical fiber bundle with a plastic layer; a vacuum water tank, disposed downstream of the extruder, and rounding the optical fiber bundle which is covered with the plastic layer to form the loose tube; and a cooling water tank, cooling the loose tube which is rounded. The manufacturing apparatus of the full-dry loose tube adopts the coupling device and electrostatic adsorption principle to couple the water-blocking powder and the optical element, thereby achieving active coupling between the optical element and the water-blocking powder, so that the water-blocking powder can be uniformly and stably adsorbed on a surface of the optical element to improve the distribution uniformity of the water-blocking powder. Adjusting the roundness of the loose tube with use of the vacuum water tank may effectively satisfy the roundness adjustment requirements of a large-sized loose tube, thereby achieving the fast shaping of the loose tube and improving the roundness of the loose tube.

### BRIEF DESCRIPTION OF DRAWINGS

The accompanying drawings, which constitute a part of the present application, are used to provide a further understanding of the present disclosure. The illustrative embodiments of the present disclosure and the description thereof are used to explain the present disclosure, and do not constitute improper limitations to the present disclosure. In the accompanying drawings:

FIG. 1 shows a structural diagram of a manufacturing apparatus of a full-dry loose tube according to an embodiment of the present disclosure;

FIG. 2 shows a three-dimensional structural diagram of a coupling device for a manufacturing apparatus of a full-dry loose tube according to an embodiment of the present disclosure; and

FIG. 3 shows a schematic structural diagram of a full-dry loose tube according to an embodiment of the present disclosure.

The above-mentioned accompanying drawings include the following reference numbers:
1. releasing device; 2. optical element; 3. optical-element electrostatic polarization device; 4. water-blocking-powder electrostatic polarization device; 5. coupling device; 51. optical element inlet mold; 52. optical element outlet mold; 53. water-blocking powder inlet mold; 54. vibrating screen; 55. water-blocking powder recycling device; 6. gas filling device; 7. extruder; 8. vacuum water tank; 9. cooling water tank; 10. drying device; 11. diameter measuring gauge; 12. traction device; 13. retracting device; 14. outer surface; 15. inner surface; 16. anti-shrinkage film; 17. water-blocking powder; 18. concave surface.

### DESCRIPTION OF EMBODIMENTS

It should be noted that the embodiments in the present application and the features in the embodiments may be combined with each other without conflict. The present disclosure would be described in detail below with reference to the accompanying drawings in conjunction with the embodiments.

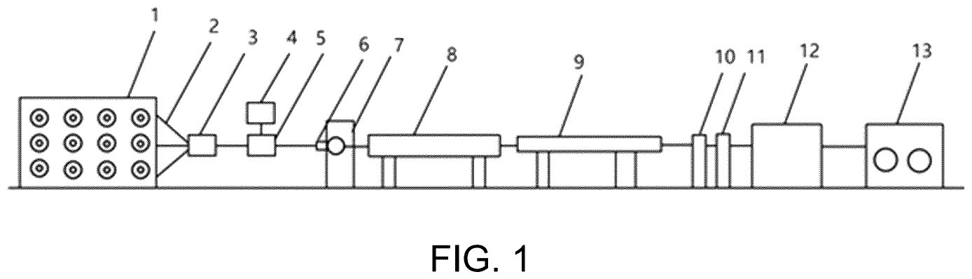

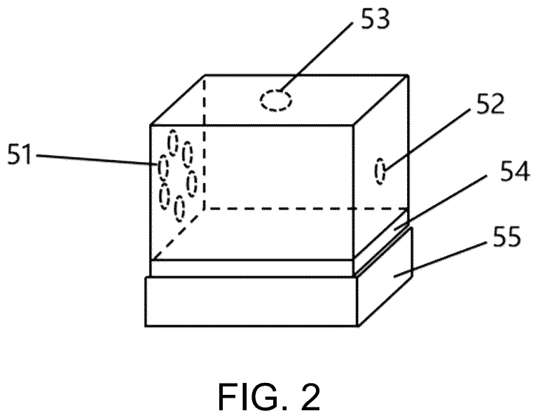

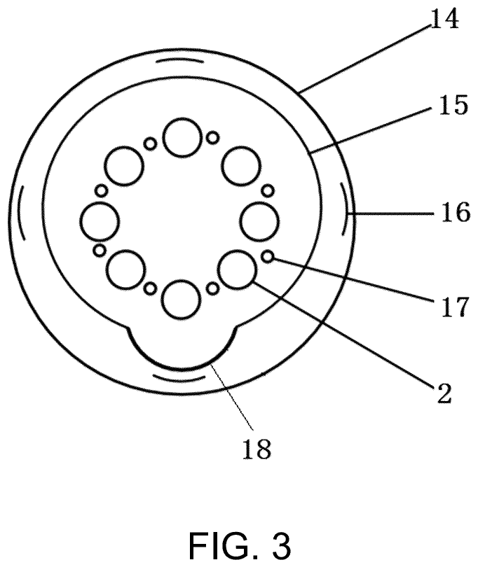

Referring to FIG. 1 to FIG. 3, according to an embodiment of the present disclosure, a manufacturing apparatus of a full-dry loose tube includes: a releasing device 1; an optical-element electrostatic polarization device 3, disposed downstream of the releasing device 1, and performing electrostatic polarization on an optical element 2 which enters the optical-element electrostatic polarization device 3; a coupling device 5, disposed downstream of the optical-element electrostatic polarization device 3, and receiving the optical element 2 which is electrostatically polarized by the optical-element electrostatic polarization device 3; a water-blocking-powder electrostatic polarization device 4, connected to the coupling device 5, and delivering water-blocking powder 17 which is electrostatically polarized to the coupling device 5, for coupling with the optical element 2 to form an optical fiber bundle, where polarity of the optical element 2 is opposite to polarity of the water-blocking powder 17; an extruder 7, receiving the optical fiber bundle and covering the optical fiber bundle with a plastic layer; a vacuum water tank 8, disposed downstream of the extruder 7, and rounding the optical fiber bundle which is covered with the plastic layer to form the loose tube; a cooling water tank 9, cooling the loose tube which is rounded.

The manufacturing apparatus of the full-dry loose tube adopts the coupling device 5 and electrostatic adsorption principle to couple the water-blocking powder 17 and the optical element 2, thereby achieving active coupling between the optical element 2 and the water-blocking powder 17, so that the water-blocking powder 17 can be uniformly and stably adsorbed on a surface of the optical element 2 to improve the distribution uniformity of the water-blocking powder 17. Adjusting the roundness of the loose tube with use of the vacuum water tank 8 may effectively satisfy the roundness adjustment requirements of a large-sized loose tube, thereby achieving the fast shaping of the loose tube and improving the roundness of the loose tube.

Generally, when the loose tube is formed, in order to ensure the roundness of the loose tube, there is a requirement for the diameter of the loose tube. When an outer diameter of the loose tube is less than or equal to 5.0 mm, by controlling the gas filling pressure and the gas flow, it is possible to achieve the forming of the loose tube with a relatively high roundness, and in this case, there is no need to use the vacuum water tank 8. When the outer diameter of the loose tube is greater than or equal to 5.0 mm, the extruding flow of the extruder 7 is large, and the gas flow required for the forming of the loose tube is also larger, when the loose tube enters the water tank, the gas filling pressure is insufficient to support the whole loose tube, causing the loose tube to droop due to its own plastic weight and resulting in forming an ellipse, and also causing the adhesion between the optical fiber and an inner wall of the loose tube. Therefore, it is necessary to adopt the vacuum water tank 8. By controlling the vacuum degree in the vacuum water tank 8, a pressure difference is generated between the inside and the outside of the loose tube to provide support for the plastic layer, thereby achieving the quick shaping, which is beneficial to improve the roundness of the large-sized loose tube. After the vacuum water tank 8 is added, the preparation requirements of the full-dry loose tube with the outer diameter of 0.8 mm to 20 mm may be effectively satisfied.

In an embodiment, the manufacturing apparatus further includes a gas filling device 6, the gas filling device 6 is disposed upstream of the extruder 7, and injects gas with a preset pressure into the plastic layer when the extruder 7 covers the optical fiber bundle with the plastic layer.

In the present embodiment, by disposing the gas filling device 6, the plastic layer may be inflated when the extruder covers the optical fiber bundle with the plastic layer, so that the plastic layer is shaped such that it is hollow inside and has a relatively high roundness at the outside to form the loose tube.

The gas filling device 6 and the vacuum water tank 8 may cooperate with each other and be used at the same time, reducing the dimensional fluctuation of the outer diameter of the loose tube, and improving the roundness of the appearance of the shaped loose tube. The vacuum water tank 8 includes components such as a vacuum pump, a vacuum sizing box, a vacuum gauge, an exhaust valve, a water regulating valve, a sizing copper pipe, or the like.

In an embodiment, the cooling water tank 9 has a plurality of temperature gradients, along a traveling direction of the optical fiber bundle, the temperature gradients gradually decrease. Cooling water in different temperature gradients circularly flows, and the cooling water with an appropriate temperature may be selected for cooling according to the temperature changes of the loose tube at different positions, which improves the cooling effect of the loose tube, and reduces the post-shrinkage of the loose tube in the cooling process, especially for large-sized loose tube.

In an embodiment, the cooling water tank 9 has three temperature gradients of 35° C., 25° C. and 15° C. respectively. A double-layer water tank is included for each temperature gradient, and the cooling water circularly flows in the double-layer water tank. The cooling water of each temperature gradient forms circulating flow through the upper-and-lower double-layer water tank, which may improve the flow efficiency of the cooling water at each temperature gradient, improve the efficiency of the heat exchange between the cooling water and the loose tube, and improve the cooling effect of the cooling water on the loose tube.

In an embodiment, the coupling device 5 includes a coupling box, the coupling box includes an optical element inlet mold 51, an optical element outlet mold 52 and a water-blocking powder inlet mold 53; where the optical element inlet mold 51 has a plurality of inlet holes, and a plurality of optical elements 2 enter the coupling device 5 through the inlet holes; the optical element outlet mold 52 is disposed at an opposite side of the optical element inlet mold 51 and has an outlet hole; the water-blocking powder inlet mold 53 is disposed at an upper side of the coupling device 5, and is connected with a spray gun of the water-blocking-powder electrostatic polarization device 4. A cavity is formed inside the coupling box for the optical element 2 to pass through and be coupled with the water-blocking powder 17.

The optical element inlet mold 51 has the plurality of inlet holes, which is beneficial for the optical element 2 to enter the coupling device 5 to form the optical fiber bundle. Each inlet hole is provided with a ceramic eye with a smooth surface, and the ceramic eye may match an appropriate inner diameter according to the size of the optical element. The inner diameter of the ceramic eye=equivalent diameter of the optical element+(0.5-1.5) mm. The plurality of inlet holes are uniformly arranged along a circumferential direction.

In an embodiment, centers of the plurality of inlet holes of the optical element inlet mold 51 are located at a same circle, the circle is coaxially provided with the outlet hole, and the optical element inlet mold 51 is rotatable relative to a central axis of the outlet hole.

In an embodiment, the optical element inlet mold 51 is a detachable structure.

The optical element inlet mold 51 is detachably assembled on the coupling box of the coupling device 5. The number of inlet holes on the optical element inlet mold 51 is not fixed, and is 1 to 48. A plurality of optical element inlet mold 51 may be manufactured, so that it is convenient to install appropriate optical elements inlet mold 51 during each production and its number of inlet holes matches the number of optical elements 2. At the same time, the optical element inlet mold 51 may achieve horizontal twisting (0 degree to ±180 degrees) by means of a power device. By means of the horizontal twisting action, firstly, control over an exceeded length may be achieved; secondly, it is ensured that each optical element 2 dispersedly enters the coupling device 5, and when optical elements 2 are stranded, a contact area between the optical elements 2 and the water-blocking powder 17 is increased; especially, in the inner space of the optical fiber bundle, the optical elements 2 may be enabled to be in contact with the water-blocking powder 17 by means of twisting, which is more conducive to the coupling with the water-blocking powder 17.

In an embodiment, the optical element outlet mold 52 is symmetrically placed on other sides of the coupling device 5 relative to the optical element inlet mold 51. The optical element outlet mold 52 only has one outlet hole. The axis of the outlet hole is parallel to the axis of each inlet hole of the optical element inlet mold 51. A smooth ceramic eye is installed on the outlet hole. The inner diameter of the ceramic eye=the equivalent diameter of the plurality of optical elements of the optical fiber bundle+(0.5-1.5) mm.

Depending on different types of the optical elements, the ceramic eye may be round, and may also be square. The ceramic eye should not be too large for prevention of powder runoff, and should not be too small for avoidance of rubbing or blockage of the optical element.

In an embodiment, the water-blocking powder inlet mold 53 is located at the upper side of the coupling device 5, and is connected with the spray gun of the water-blocking-powder electrostatic polarization device 4, so that the water-blocking powder 17 is sprayed from top to bottom. The size and shape of the water-blocking powder inlet mold 53 are matched with that of the spray gun.

In order to ensure the spraying effect of the water-blocking powder, depending on the number and type of the optical elements, the shape of the water-blocking powder inlet mold 53 may be circular, linear, a dot array, or the like.

In an embodiment, the coupling device 5 further includes a vibrating screen 54 and a water-blocking powder recycling device 55, where the coupling box is open at its bottom, the vibrating screen 54 is disposed at the bottom of the coupling box, and the water-blocking powder recycling device 55 is disposed below the vibrating screen 54.

The vibrating screen 54 is located below a coupling space, for the purpose of preventing the surplus and non-adhered water-blocking powder from accumulating at the bottom of the coupling space, so that the surplus water-blocking powder enters the water-blocking powder recycling device 55 by means of mechanical vibration. The vibrating screen 54 is provided with a sensor, which may sense the accumulated weight of the water-blocking powder, thereby achieving the automated starting of the vibrating screen and the control of the vibration frequency.

In an embodiment, the water-blocking powder recycling device 55 includes a heating device, a conduit and a pneumatic device, where the conduit is connected with a storage container for storing the electrostatically polarized water-blocking powder 17, the heating device is configured to heat the water-blocking powder 17 recycled in the water-blocking powder recycling device 55, and the pneumatic device is configured to suck the water-blocking powder 17 to the storage container.

The water-blocking powder recycling device 55 is configured to store the recycled water-blocking powder 17, and the water-blocking powder recycling device 55 includes an infrared heating device, which is configured to dry the water-blocking powder 17. The water-blocking powder recycling device 55 is connected with the storage container of the electrostatically polarized water-blocking powder 17 through the conduit, and is equipped with the pneumatic device, which may achieve the recycle and reuse of the water-blocking powder. The water-blocking powder recycling device 55 is also provided with a sensor. When the water-blocking powder is accumulated to a certain amount, the pneumatic device automatically sucks it to the storage container of the electrostatically polarized water-blocking powder.

According to an embodiment of the present disclosure, a manufacturing method of a full-dry loose tube, applied to the above-mentioned manufacturing apparatus, includes: releasing the optical element 2; performing electrostatic polarization on the released optical element 2; adding the water-blocking powder 17 which is electrostatically polarized and has the opposite polarity, to the electrostatically polarized optical element 2, so that the optical element 2 and the water-blocking powder 17 are coupled to form the optical fiber bundle; extruding the optical fiber bundle and making the extruded optical fiber bundle form the loose tube; and shaping, cooling and retracting the loose tube.

In an embodiment, a step of extruding the optical fiber bundle and making the extruded optical fiber bundle form the loose tube includes:
injecting gas into the plastic layer during an extruding process, so that the plastic layer is hollow inside to form the loose tube;
delivering the loose tube to the vacuum water tank 8, and adjusting roundness of the loose tube by using the vacuum water tank 8.

In an embodiment, a step of adding water-blocking powder 17 which is electrostatically polarized and has the opposite polarity, to the electrostatically polarized optical element 2, so that the optical element 2 and the water-blocking powder 17 are coupled to form the optical fiber bundle includes:
controlling a plurality of optical elements 2 to be twisted and stranded, and adding the water-blocking powder 17 during a twisting and stranding process, where the water-blocking powder 17 is sprayed from top to bottom by the spray gun of the water-blocking-powder electrostatic polarization device 4 through the water-blocking powder inlet mold 53.

In the step of releasing the optical element, at least one optical element is installed on the releasing device, and active releasing is adopted. The optical element 2 is a bare fiber or an optical fiber combination with resin and a plastic covering layer. The number of optical fibers is not less than one core. According to the number of optical fibers and the optical-fiber covering layer, an optical-fiber releasing tension is adjusted between 0.5 N and 3 N. A typical optical fiber combination has a flat-type or a round-type or windable optical fiber ribbon or a plastic tight-sheathed optical fiber.

The optical element is released into the electrostatic polarization device, and current and frequency are set by an electronic controller, so that the optical element is electrostatically polarized and its surface is positively charged.

The water-blocking powder 17 is dried in the storage container, and is conveyed to the water-blocking-powder electrostatic polarization device 4 at a certain air pressure. Electrostatic frequency, electric field density and power are set by the electronic controller, so that the water-blocking powder is negatively charged. Then, the electrostatically polarized water-blocking powder is sprayed out at a certain pressure through a water-blocking powder spray gun. Both the conveying of the water-blocking powder and the spraying of the water-blocking powder are controlled by an adjustable air pressure, and linkage is achieved, that is, the larger the spraying amount is, the larger the conveying amount of the water-blocking powder is.

After electrostatic polarization, the positively-charged optical element 2 and the negatively-charged water-blocking powder 17 are gathered in the coupling device 5. According to the electrostatic adsorption principle, the water-blocking powder is uniformly and stably adsorbed on the surface of the optical element.

By adjusting the charged capacity of the optical element and controlling the powder spraying flow, the control of the adsorption amount of the water-blocking powder may be achieved, thereby achieving the control of the filling amount of the water-blocking powder under different tube sizes and different numbers of optical fiber cores, and ensuring stable water-blocking performance.

In the step of extruding the optical fiber bundle, the optical element 2 is coupled with the water-blocking powder 17 to form a water-blocking optical fiber bundle. Through the gas filling device 6 and the extruder 7, the periphery of the optical fiber bundle is covered with the plastic layer to form the loose tube. The plastic layer is shaped by the gas filling device such that it is hollow inside and has a relatively high roundness at the outside to form the loose tube.

In the step of shaping, cooling and retracting the loose tube, the loose tube coming out of the extruder sequentially passes through the vacuum water tank 8, the cooling water tank 9, the drying device 10, the diameter measuring gauge 11 and the traction device 12, and after the size and appearance of the loose tube are determined, the loose tube is retracted by the retracting device 13, thereby achieving the preparation of the full-dry loose tube.

According to an embodiment of the present disclosure, a loose tube applies the above-mentioned manufacturing method. The loose tube includes a plastic layer, water-blocking powder 17 and an optical element 2, where the water-blocking powder 17 is coated outside the optical element 2 to form an optical fiber bundle, the plastic layer is covered outside the optical fiber bundle, the plastic layer includes an inner surface 15 and an outer surface 14, and the inner surface 15 includes a rounding surface and a concave surface 18.

In an embodiment, the performance indexes of the adopted water-blocking powder are as follows: particle size≤100μm, water absorption≥300 ml/g, water content≤3%, expansion rate≥15 mm/min, and 3-minute expansion height≥18 mm.

In order to reduce the frictional resistance of the plurality of optical elements 2 during the filling process, a certain proportion of lubricant powder may be mixed in the water-blocking powder 17. Common lubricant powder includes polyethylene wax, calcium stearate, talcum powder, molybdenum disulfide, silicon micropowder, and the like, and its addition amount is 0.2% to 0.8% by weight of the water-blocking powder.

In an embodiment, a radian proportion by which the concave surface 18 occupies the inner surface 15 of the plastic layer is 10% to 25%.

In an embodiment, a curvature radius of the concave surface 18 is less than or equal to half of thickness of the plastic layer in which the concave surface 18 is located; and/or a radian of the concave surface 18 ranges from 0 to π.

By limiting the radian and the curvature radius of the concave surface 18, it is possible to avoid that the compressive strength of the loose tube would be affected as a result of the minimum thickness being undersized at the concave surface due to the curvature radius of the concave surface being oversized.

In an embodiment, the concave surface 18 is a rough surface.

By means of special design of the extruding mould, the concave surface is made to be non-smooth, and the non-smooth surface has linear grains. Common grains include, such as waves, lines, or the like.

The above-mentioned design of the inner surface of the plastic layer has the following functions: a. lessening the falling-off of the water-blocking powder 17 from the loose tube. During long-term storage, laying and use of the loose tube filled with the water-blocking powder 17, the coupling force between the water-blocking powder 17 and the optical element 2 will gradually decrease under the influence of external vibration, that is, the water-blocking powder 17 is subject to a phenomenon of falling-off and may easily run off from the loose tube, thereby affecting the water-blocking performance. However, due to the design of a non-smooth concave surface for the inner surface, the water-blocking powder 17 is enabled to adhere to the concave surface 18, thereby lessening the runoff of the water-blocking powder 17 from the loose tube, which is especially suitable for the scenario in which the optical cable needs to be vertically installed and laid. b. The concave surface 18 may also store and aggregate the water-blocking powder 17 falling off from the optical element 2, so that the water-blocking powder 17 that is fallen off does not affect the transmission performance of the optical fiber, and the water-blocking powder 17 can still be stored in the loose tube, thereby not affecting the water-blocking performance.

In an embodiment, the plastic layer is filled with at least one anti-shrinkage film 16 continuously extending along an axial direction of the loose tube, and the anti-shrinkage film 16 is arc-shaped on a cross section of the loose tube, so as to prevent the axial shrinkage of the loose tube, especially the large-sized loose tube, and to solve the problem of post-shrinkage in the forming process.

In an embodiment, the anti-shrinkage film 16 has a longitudinal shrinkage ratio of ≤0.2% at 250° C. to 300° C., a thickness of 0.05 mm to 0.2 mm, and a width of 0.5 mm to 5 mm.

The anti-shrinkage film has excellent thermal stability: the longitudinal shrinkage ratio of ≤0.2% at 250° C. to 300° C., the thickness of 0.05 mm to 0.2 mm, and the width of 0.5 mm to 5 mm. The anti-shrinkage film is curved in the plastic layer at a certain radian. A common anti-shrinkage film is one of a polyimide film, a liquid crystal polymer film, a polybenzimidazole film and a polytetrafluoroethylene film.

In an embodiment, the anti-shrinkage film 16 is spirally disposed in the plastic layer at a certain pitch, and the post-shrinkage ratio of the loose tube is less than or equal to 0.2%.

In an embodiment, an outer diameter of the loose tube ranges from 0.8 mm to 20 mm, and a wall thickness ranges from 0.08 mm to 1 mm; when the outer diameter of the loose tube is less than or equal to 5.0 mm, the plastic layer is made of one of PBT (Polybutylene Terephthalate), PP (Polypropylene), TPEE (Thermoplastic Polyester Elastomer) and PC (Polycarbonate); when the outer diameter of the loose tube is greater than 5.0 mm, the plastic layer is made of one of TPEE, PE (Polyethylene) and PP.

According to an embodiment of the present disclosure, an optical cable includes a cable core prepared by the above-mentioned loose tube and an outer sheath covering the cable core.

The main advantages of the present disclosure are as follows.
1. An electrostatic polarization process is adopted, and electrostatic frequency, electric field density and power are set by means of an electronic controller, thereby achieving that the optical element and the water-blocking powder are positively and negatively charged respectively, and that the charge capacity is controllable.
2. The coupling device for the optical element and the water-blocking powder is designed, thereby achieving the active coupling of the water-blocking powder on the surface of the optical element, and achieving the control of the adsorption amount of the water-blocking powder by adjusting the powder out-spraying amount. At the same time, automatic recycling and reuse of the surplus water-blocking powder can be achieved.
3. By means of a production system of the full-dry loose tube, preparations of different-specification tubes with the outer diameter of 0.8 mm to 20 mm, the wall thickness of 0.08 mm to 1 mm, and the out-of-roundness of ≤5% can be achieved. The maximum number of optical fiber cores which can be accommodated in a single tube can reach 864 cores, which can satisfy the application requirements of optical cables with different numbers of cores. The plastic layer of the loose tube is filled with the anti-shrinkage film, which effectively improves the longitudinal post-shrinkage of the loose tube. The special design of the inner surface is used to reduce the risk of the runoff the water-blocking powder from the tube, and the water-blocking stability of the tube is improved during long-term use.

It should be noted that the terms used herein are merely for describing specific embodiments, and are not intended to limit exemplary embodiments according to the present application. As used herein, unless the context clearly indicates otherwise, the singular form is also intended to include the plural form. Further, it should be understood that when the terms “comprise” and/or “include” are used in the present specification, they indicate the presence of features, steps, operations, devices, components, and/or combinations thereof.

It should be noted that the terms “first” and “second” in the specification, claims and above accompanying drawings of the present application are used to distinguish similar objects, and are not necessarily used to describe a specific sequence or order. It should be understood that the data used herein may be interchanged where appropriate, so that the embodiments of the present application described herein can be implemented in sequences other than those illustrated or described herein.

The above description is merely the embodiments of the present disclosure, and is not intended to limit the present disclosure. For those skilled in the art, there may be various modifications and variations to the present disclosure. Any modifications, equivalent replacements, improvements and the like made within the spirit and principle of the present disclosure shall fall within the protection scope of the present disclosure.

What is claimed is:

1. A manufacturing apparatus of a full-dry loose tube, comprising:
a releasing device;
an optical-element electrostatic polarization device, disposed downstream of the releasing device, and performing electrostatic polarization on an optical element which enters the optical-element electrostatic polarization device;
a coupling device, disposed downstream of the optical-element electrostatic polarization device, and receiving the optical element which is electrostatically polarized by the optical-element electrostatic polarization device;
a water-blocking-powder electrostatic polarization device, connected to the coupling device, and delivering water-blocking powder which is electrostatically polarized to the coupling device, for coupling with the optical element to form an optical fiber bundle, wherein polarity of the optical element is opposite to polarity of the water-blocking powder;
an extruder, receiving the optical fiber bundle and covering the optical fiber bundle with a plastic layer;
a vacuum water tank, disposed downstream of the extruder, and rounding the optical fiber bundle which is covered with the plastic layer to form the loose tube; and
a cooling water tank, cooling the loose tube which is rounded.

2. The manufacturing apparatus according to claim 1, further comprising: a gas filling device, wherein the gas filling device is disposed upstream of the extruder, and injects gas with a preset pressure into the plastic layer when the extruder covers the optical fiber bundle with the plastic layer.

3. The manufacturing apparatus according to claim 1, wherein the coupling device comprises a coupling box, the coupling box comprises an optical element inlet mold, an optical element outlet mold and a water-blocking powder inlet mold, the optical element inlet mold has a plurality of inlet holes, and a plurality of optical elements enter the coupling device through the inlet holes; the optical element outlet mold is disposed at an opposite side of the optical element inlet mold, and has an outlet hole; the water-blocking powder inlet mold is disposed at an upper side of the coupling device, and is connected with a spray gun of the water-blocking-powder electrostatic polarization device.

4. The manufacturing apparatus according to claim 3, wherein centers of the plurality of inlet holes of the optical element inlet mold are located at a same circle, the circle is coaxially provided with the outlet hole, and the optical element inlet mold is rotatable relative to a central axis of the outlet hole.

5. The manufacturing apparatus according to claim 3, wherein the optical element inlet mold is a detachable structure.

6. The manufacturing apparatus according to claim 3, wherein the coupling device further comprises a vibrating screen and a water-blocking powder recycling device, the coupling box is open at its bottom, the vibrating screen is disposed at the bottom of the coupling box, and the water-blocking powder recycling device is disposed below the vibrating screen.

7. The manufacturing apparatus according to claim 6, wherein the water-blocking powder recycling device comprises a heating device, a conduit and a pneumatic device, the conduit is connected with a storage container for storing the electrostatically polarized water-blocking powder, the heating device is configured to heat the water-blocking powder recycled in the water-blocking powder recycling device, and the pneumatic device is configured to suck the water-blocking powder to the storage container.

8. A manufacturing method of a full-dry loose tube, applied to the manufacturing apparatus according to claim 1, comprising:
releasing the optical element;
performing electrostatic polarization on the released optical element;
adding the water-blocking powder which is electrostatically polarized and has the opposite polarity, to the electrostatically polarized optical element, so that the optical element and the water-blocking powder are coupled to form the optical fiber bundle;
extruding the optical fiber bundle and making the extruded optical fiber bundle form the loose tube; and
shaping, cooling and retracting the loose tube.

9. The manufacturing method according to claim 8, wherein a step of extruding the optical fiber bundle and making the extruded optical fiber bundle form the loose tube comprises:
injecting gas into the plastic layer during an extruding process, so that the plastic layer is hollow inside to form the loose tube;
delivering the loose tube to the vacuum water tank, and adjusting roundness of the loose tube by using the vacuum water tank.

10. The manufacturing method according to claim 8, wherein a step of adding the water-blocking powder which is electrostatically polarized and has the opposite polarity, to the electrostatically polarized optical element, so that the optical element and the water-blocking powder are coupled to form the optical fiber bundle comprises:
controlling a plurality of optical elements to be twisted and stranded, and adding the water-blocking powder during a twisting and stranding process, wherein the water-blocking powder is sprayed from top to bottom by the spray gun of the water-blocking-powder electrostatic polarization device through the water-blocking powder inlet mold.

11. A loose tube, applying the manufacturing method according to claim 8, wherein the loose tube comprises a plastic layer, water-blocking powder and an optical element, the water-blocking powder is coated outside the optical element to form an optical fiber bundle, the plastic layer is covered outside the optical fiber bundle, the plastic layer comprises an inner surface, and the inner surface comprises a rounding surface and a concave surface.

12. The loose tube according to claim 11, wherein a radian proportion by which the concave surface occupies the inner surface of the plastic layer is 10% to 25%.

13. The loose tube according to claim 11, wherein a curvature radius of the concave surface is less than or equal to half of thickness of the plastic layer in which the concave surface is located;
and/or a radian of the concave surface ranges from 0 to π.

14. The loose tube according to claim 11, wherein the concave surface is a rough surface.

15. The loose tube according to claim 11, wherein the plastic layer is filled with at least one anti-shrinkage film continuously extending along an axial direction of the loose tube, and the anti-shrinkage film is arc-shaped on a cross section of the loose tube.

16. The loose tube according to claim 15, wherein the anti-shrinkage film has a longitudinal shrinkage ratio of ≤0.2% at 250° C. to 300° C., a thickness of 0.05 mm to 0.2 mm, and a width of 0.5 mm to 5 mm.

17. The loose tube according to claim 11, wherein an outer diameter of the loose tube ranges from 0.8 mm to 20 mm, and a wall thickness ranges from 0.08 mm to 1 mm; when the outer diameter of the loose tube is less than or equal to 5.0 mm, the plastic layer is made of one of PBT, PP, TPEE and PC; when the outer diameter of the loose tube is greater than 5.0 mm, the plastic layer is made of one of TPEE, PE and PP.

18. An optical cable, comprising a cable core prepared by the loose tube according to claim 11 and an outer sheath covering the cable core.

19. The optical cable according to claim 18, wherein a radian proportion by which the concave surface occupies the inner surface of the plastic layer is 10% to 25%.

20. The optical cable according to claim 18, wherein a curvature radius of the concave surface is less than or equal to half of thickness of the plastic layer in which the concave surface is located; and/or a radian of the concave surface ranges from 0 to π.
